(19) United States
(12) Patent Application Publication
(10) Pub. No.: US 2011/0233246 A1
(43) Pub. Date: Sep. 29, 2011

(54) SYSTEM FOR TRANSPORTING ITEMS ON VEHICLES

(76) Inventor: Thomas Vollbrecht, Park City, UT (US)

(21) Appl. No.: 12/953,440

(22) Filed: Nov. 23, 2010

Related U.S. Application Data
(60) Provisional application No. 61/281,877, filed on Nov. 23, 2009.

(51) Int. Cl. B60R 9/04

(52) U.S. Cl. 224/315; 224/325

(57) ABSTRACT

A roof rack system includes structures for connecting item holders to crossbars which simplify the attachment the item holders. The structures include slots in the crossbars and extensions on the items holders to mate with the slots. One of the crossbars includes a locking mechanism for locking the item holders into the crossbar. The locking mechanism includes a rod within the crossbar which mates with the extension on the item holder to retain the extension within the crossbar.

### CROSS REFERENCE TO RELATED APPLICATION

This application claims the benefit of provisional patent application Ser. No. 61/281,877 filed Nov. 23, 2009.

### BACKGROUND OF THE INVENTION

1. Field of the Invention

The present invention relates to rack systems for attaching items to the roof of a vehicle for transportation. More particularly, the invention relates to a system for easily attaching item supports to crossbars on a vehicle rack.

2. Discussion of Related Art

There are many designs for racks to attach items to the roof of a vehicle for transport. Many carrier racks are designed for mounting to the roof of vehicles such as automobiles to transport cargo, recreational equipment and the like. However, such racks have have many disadvantages.

Racks available today have static crossbars, typically in the form of a square or round steel tube or an ovalized aluminum extrusion. The mechanisms for affixing attachments (e.g. bike carriers, ski carriers, cargo boxes, etc.) to those static crossbars are integrated into the attachments. This results in the repetition of securing each individual attachment to each of the crossbars. Further, the securing mechanisms themselves are awkward and require, at a minimum, several minutes to either affix or detach each individual attachment. In addition, there is no integration of the attachments to either the storage of the individual attachments nor the storage of the items that are typically transported on each attachment (e.g. bikes, skis, kayaks, etc.).

Rack owners often leave many attachments on their crossbars because they are difficult to configure. Leaving the attachments on the roof rack increases aerodynamic drag. This creates increased wind noise and lowers gas mileage. Each vehicle used by the owner needs to have its own set of attachments, or the user must dedicate substantial time to moving the attachments from one vehicle to another. Leaving the attachments on the roof rack also causes unnecessary wear-and-tear on the attachments because they are frequently exposed to weather and the elements, even when not in use.

Racks today have crossbars that are not aerodynamic in shape. The coefficients of drag on the typical square, round and oval shapes are much higher than airfoil shapes. This causes increased wind noise. The higher drag also negatively impacts gas mileage.

Several attempts to simplify the configuration process have been proposed. For example, in U.S. Patent Application Publication US 2008/0029563 to Malone proposes an adapter, which is to be mounted on an existing set of crossbars. This requires each adapter to be mounted separately to a set of crossbars. While this would allow a user to put one specific attachment onto a set of crossbars, it can only be configured for that one attachment. Further, it requires a separate “locking pin” and security lock be used for each adapter, which results in substantial repetition of motion. The invention makes no accommodation for integrated storage.

In U.S. Pat. No. 5,738,258 to Farrow et al., suggests a system to accommodate multiple sporting goods without the need for additional towers, crossbars or attachments. The system is not aerodynamic and is likely to create substantial wind noise and reduction in gas mileage while affixed to a vehicle. It also is permanent in its configuration, so it does not accommodate a user's ever-changing carrying needs. It also fails to preclude unauthorized removal of equipment or the system itself. There is no mention of integration of storage.

In U.S. Pat. No. 4,955,519 to Forrester, a method for using a dovetail type joint to quickly attached and remove a specific ski case attachment is described. This quick release system is inferior in that it requires the user to either clamp the guide to an existing rack or screw it permanently to a rooftop. This invention also requires its ski case to be constructed with an integrated dovetail so as to fit into the proposed guide, so it is not universal in its application. The invention is limiting because it can be only incrementally configured. It requires the ski case to be slid from the side onto the guide from only one side of the vehicle with a permanent stop on the alternate side of the vehicle. Consequently, any ski case that is mounted nearer the open side of the guide must be removed prior to any ski case mounted closer to the permanent stop.

In U.S. Pat. No. 3,325,069 to Fulton, a dedicated ski carrier is described. This device is not capable of accommodating any equipment other than skis. It is not aerodynamic in its design and would result in substantial wind noise and reduced mileage when not in use.

It is desirable to have a means of very quickly and easily securing attachments such as bike carriers, ski carriers and cargo boxes, to the roof rack and, ideally, of having such a means that will accommodate the shapes and sizes of various attachments from a variety of manufacturers. It is also desirable to have a means to very quickly and easily secure the associated equipment, such as bicycles and skis, along with each attachment. It is also desirable to have a means that will prevent unauthorized removal of the attachments and gear mounted on the roof rack. It is also desirable to have a means to store the attachments and their associated equipment together, out of the way and ready to quickly mount to the roof rack.

### SUMMARY OF THE INVENTION

The present invention substantially overcomes the deficiencies of the prior art roof rack systems by providing a locking mechanism integrated with a crossbar of the roof rack. The present invention allows for securing of all attachments to the crossbars in one easy step, with a single action that speeds the attachment affixing and/or removal process.

The locking mechanism of the present invention includes a plurality of slots within a crossbar. An actuator rod is positioned within the crossbar. The actuator operates to lock attachments to the crossbar. The attachments include extensions with fit within the slots of the crossbar and interact with the actuator rod. The use of the slots and extensions allow for easy and rapid repositioning of attachments. The relationship between the crossbar and attachments allows attachments to remain in a stable, hands-free status on the crossbar prior to securing in place, which aids in the positioning and re-positioning of attachments with or without their respective items attached. The present invention allows for rapid mounting, removal and storage of roof-top boxes, which provides users the ability to more readily access garages and parking ramps. The height of such roof-top boxes makes it impossible for some vehicles to fit through garage door openings or into parking ramps with the roof-top box in place.

According to another aspect of the invention, a keyed lock is included within an end of the crossbar and attached to the actuator rod. A key is required to change the actuator rod from the locked position.

According to another aspect of the invention, the extensions are symmetrical to facilitate simple and rapid front-to-back or back-to-front reversal of attachments.

According to another aspect of the invention, a bracket can be attached to a wall. The bracket mates with the extensions on the attachments. This allows for seamless and rapid storage of either attachments (e.g. boxes or basket) or attachments along with affixed relevant equipment (e.g. bike attachment with affixed bicycle).

Since the crossbar and attachments have a consistent arrangement, attachments are easily interchangeable between vehicles having the system installed. Because attachments can fit rapidly onto the system on every vehicle where it is installed, attachments can be easily and quickly moved from vehicle to vehicle. Additionally, the system has a reduced cost/investment because attachments can be transferred quickly and easily from vehicle to vehicle thereby requiring users only one attachment for each item (such as a bicycle holder).

The attachments can be easily removed from the vehicle when not in use. This leads to reduced windage on vehicles, better gas mileage, the resulting cost savings and a lower CO2 footprint, which aids the reduction in greenhouse gas emissions. It also reduces wear-and-tear on attachments because they don't have to be out in the elements (sun and weather) all the time; only when they are being used. When they are not in use, attachments and/or their related equipment are conveniently stored out of the elements.

### BRIEF DESCRIPTION OF THE DRAWINGS

FIG. 1 is a top perspective view of a rail.

FIG. 2 is a top perspective view of a center actuator rod.

FIG. 3 is a top perspective of an integrated lock handle.

FIG. 4 is a top perspective view of an actuator rod block.

FIG. 5 is a top-left perspective view of a lock side cap.

FIG. 6 is a top-left perspective view of a lock insert.

FIG. 7 is a top-right perspective view of a plunger handle lock.

FIG. 8 is a top-left perspective view of a left end cap.

FIG. 9 is a top-left perspective view of a right end cap.

FIG. 10 is a top perspective view of a universal rail adapter.

FIG. 11 is a top perspective view of an adapter retention plate.

FIG. 12 is a top perspective view of an adapter rectangular sleeve.

FIG. 13 is a top perspective view of an adapter circular sleeve.

FIG. 14 is a top perspective view of a close out panel.

FIG. 15 is a top perspective view of a slide mounting block.

FIG. 16 is a top perspective view of a sliding plug block.

FIG. 17 is an exploded view of a first embodiment of my invention.

### DETAILED DESCRIPTION

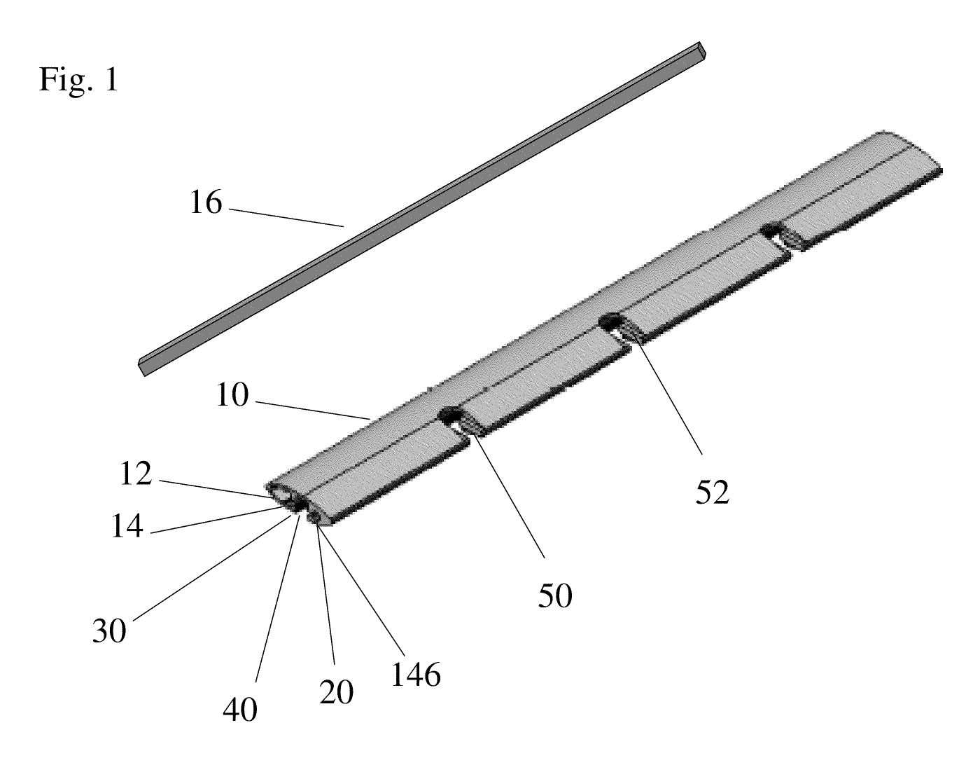

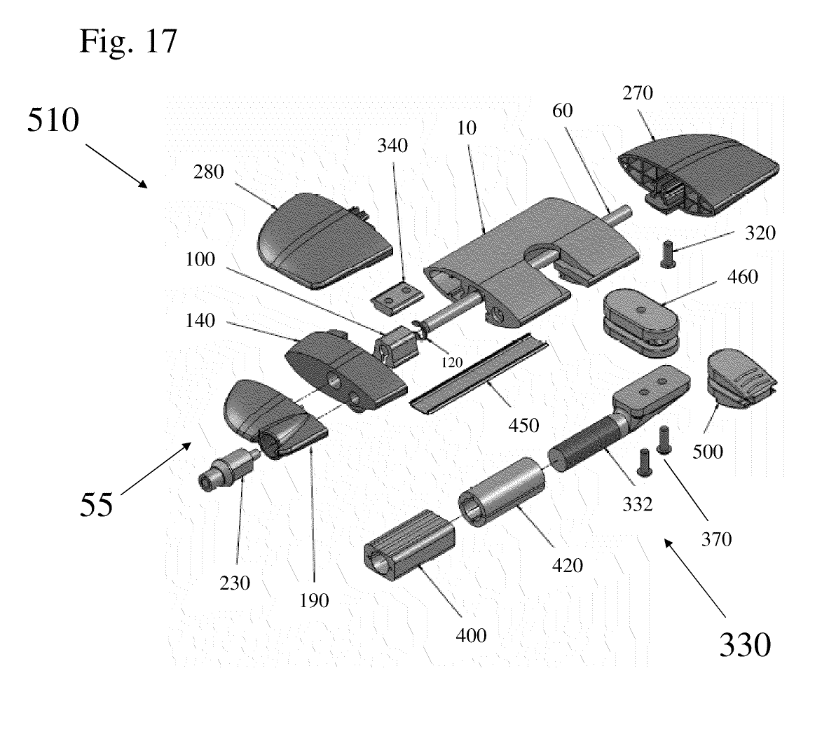

One embodiment of the sports rack system is illustrated in FIG. 1-FIG. 18, also referred to as a rail assembly 510 shown in the exploded view in FIG. 18. The sports rack system is comprised of two rails or crossbars 10 shown in FIG. 1. The rail has a rail end bore 20 in the left end. The rail also includes a rod block receiver groove 30 and a close out panel receiver groove 40. The rail also has a series of standard slider receiver openings 50 that are of a standardized size and are set at consistent center-to-center distances along the length of the rail 10. Each standard slider receiver opening 50 incorporates standard sized insertion tabs 52 on either side. The rail 10 also incorporates a rail stiffener rod cavity 14 that runs transversely through the front section of the rail 10. In some instances where it is desirable to stiffen the rail 10, a rail stiffener rod 16 can be driven into the rail stiffener rod cavity 14.

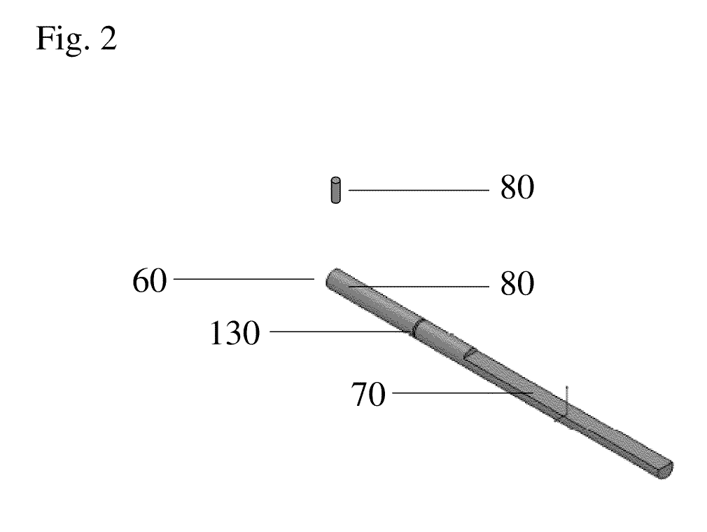

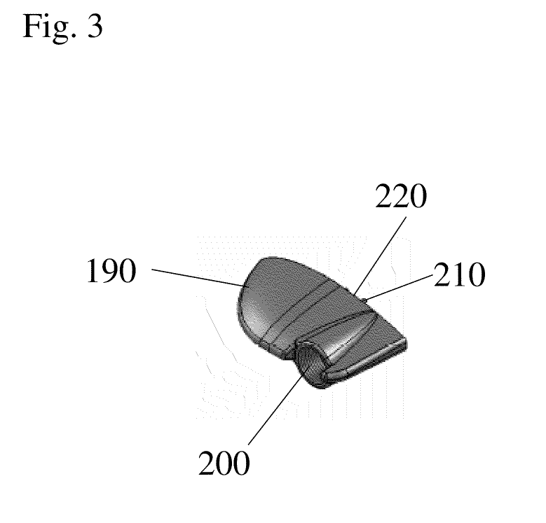

One of the Rails contains a locking mechanism 55 comprised of a center actuator rod 60 shown in more detail in FIG. 2, an Integrated Lock Handle 190, shown in FIG. 3, shown in more detail in FIG. 3 and a roll pin 90. According to a preferred embodiment, the second of the two rails in this embodiment does not include the locking mechanism. Of course, both rods could include a locking mechanism.

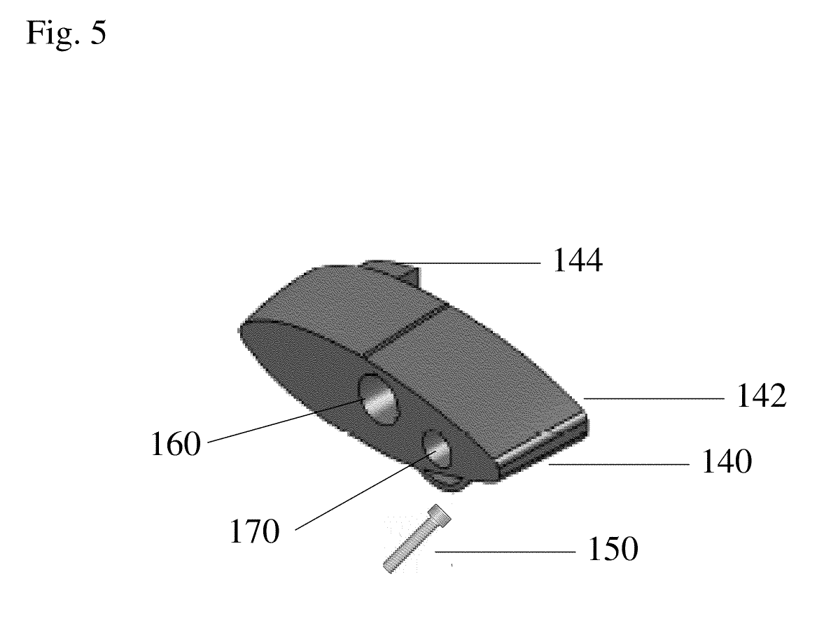

The center actuator rod 60, shown in FIG. 2, consists of a length of aluminum rod and includes a series of center actuator rod flat openings 70 at consistent center-to-center distances along the length of the center actuator rod 60. The center-to-center distances along the length of the center actuator rod 60 are the same as the center-to-center distances of the standard slider receiver openings 50 in the rail10. The center actuator rod 60 also includes a lock ring groove 130, which is designed to accommodate a lock ring 120, which is installed to prevent the center actuator rod 60 from being removed out of a lock side cap 140, shown in FIG. 5. The end of the center actuator rod 60 nearest the lock ring groove 130 is the center actuator rod threaded end 80.

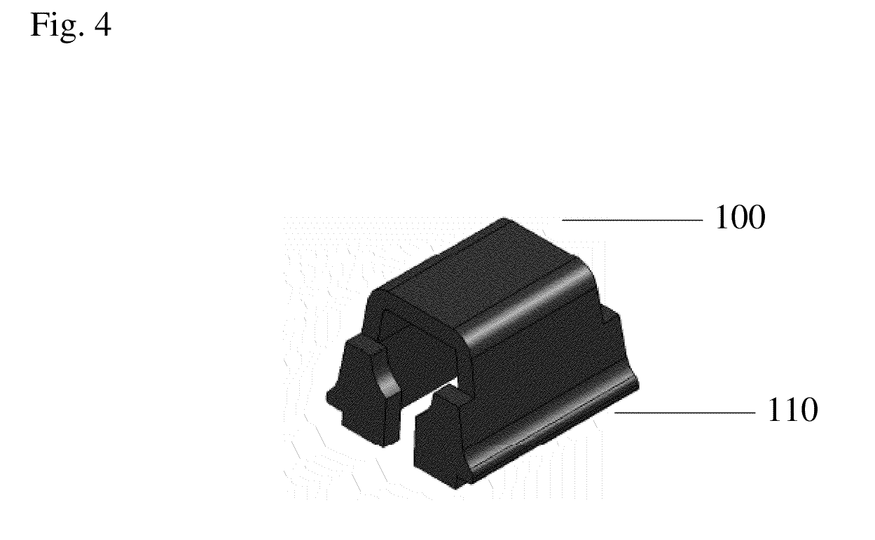

The center actuator rod 60 is supported within the rail 10 by means of insertion through a series of actuator rod blocks 100, shown in FIG. 4. The actuator rod block 100 is designed to snap into the rod block receiver groove 30 within the rail 10. The rod block incorporates two rod block receiver groove tabs 110, which fit firmly inside the rod block receiver groove 30 thereby holding the actuator rod block 100 in place.

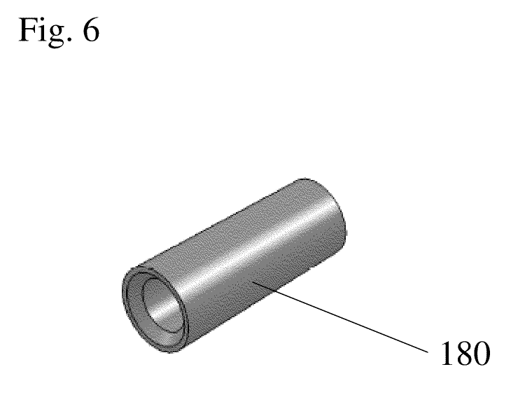

The rail 10 that incorporates the locking mechanism 55 has a lock side cap 140 fitted to the left end of the rail 10. The lock side cap 140 has two guide features to properly align the lock side cap 140 onto the rail 10. The first guide is a lock side cap rear alignment guide 142, which is a circular protrusion that extends beyond the inside edge of a lock insert receiver hole 170. The lock side cap rear alignment guide 142 fits securely inside the rail end bore 20. The second guide is a lock side cap front alignment guide 144, which fits securely inside a rail front cavity 12. A lock side cap securing screw 150 is inserted into the lock insert receiver hole 170 and protrudes through an opening in the end of the lock insert receiver hole 170. The lock side cap securing screw 150 is then fastened into a threaded lock side cap securing hole 146 to secure the lock side cap 140 to the rail 10. After the lock side cap 140 is secured to the rail 10 with the lock side cap securing screw 150, a lock insert 180, shown in FIG. 6, is inserted into the lock insert receiver hole 170. The lock insert 180 is of a slightly larger diameter than the lock insert receiver hole 170. Consequently, a moderate amount of pressure is needed to push the lock insert 180 into the lock insert receiver hole 170 for a semi-permanent mounting of the lock insert 180.

Approximately in the center of the inside surface of the integrated lock handle 190 is a lock handle center actuator rod threaded hole 220. The center actuator rod threaded end 80 is then screwed into the lock handle center actuator rod threaded hole 220. Subsequently, a hole is drilled through both the center actuator rod 60 and the integrated lock handle 190 through which a roll pin 90 is inserted. The lock side cap 140 has an actuator rod receiver hole 160 through which the center actuator rod 60 is inserted, followed by the center actuator rod 60 being inserted through the actuator rod blocks 100 previously snapped into place in the rod block receiver groove 30 in the rail 10.

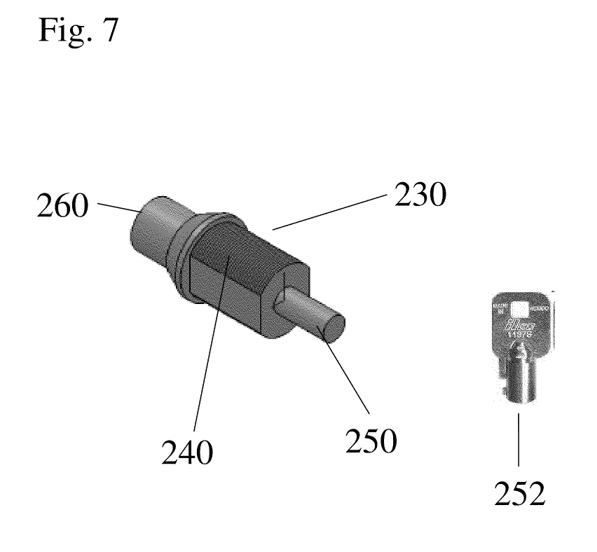

The integrated lock handle 190 incorporates a Lock Handle Plunger Lock Receiver Threaded Hole 200 that is horizontal to the primary plain of the integrated lock handle and is threaded to accept plunger handle lock threads 240 of a plunger handle lock 230, shown in FIG. 7. The plunger handle lock includes a plunger handle lock dead bolt 250 and a plunger handle lock key receiver 260.

There are Lock Handle 90 Degree Turn Stops 210 protruding from the outside diameter of the inside edge of the lock handle center actuator rod threaded hole 220. The lock handle 90 degree turn stops 210 allow the integrated lock handle 190 to turn through no more than 90 degrees, starting with the integrated lock handle 190 aligned with the lock side cap 140 and ending with the integrated lock handle 190 pointing straight up, oriented 90 degrees to the lock side cap 140.

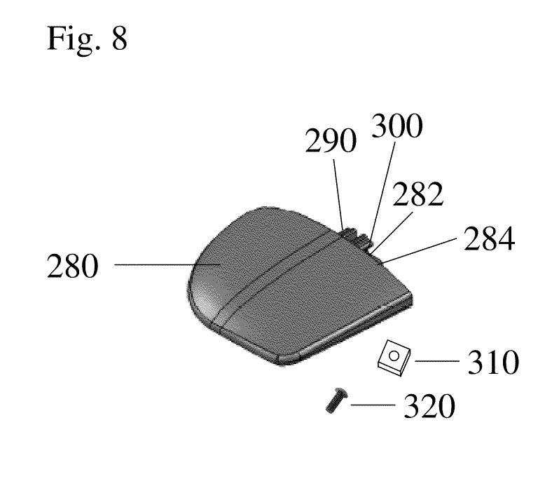

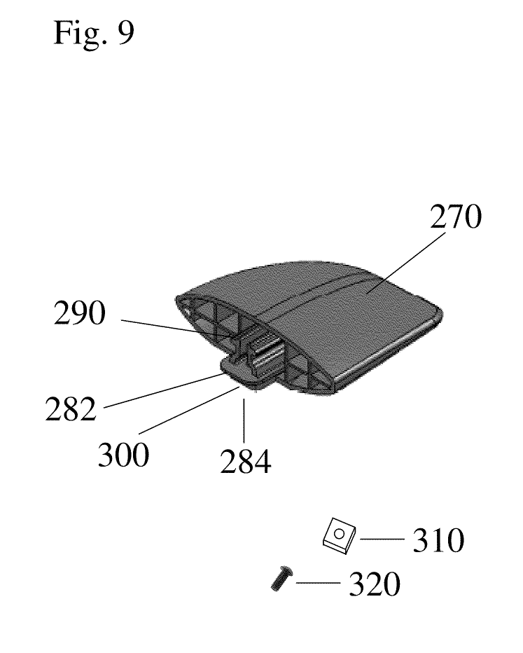

This embodiment includes a right end cap 270, shown in FIG. 9, and a left end cap 280, shown in FIG. 8. The right end cap 270 and the left end cap 280 are mirror images of each other. Each end cap includes an end cap tab 282 that protrudes from the inside edge of the end cap 270 and 280 that is parallel to the main plain of the end cap 270 and 280. Extending 90 degrees from each end cap tab 282 is an end cap expansion joint 290. Between the end cap expansion joint 290 and the end cap tab 282 is an end cap square nut receiver cavity 300 that accommodates a square nut 310 that is inserted parallel to the main plane of the end cap 270 and 280. Along the bottom surface of the end cap 270 and 280 is an end cap securing screw hole 284 through which is inserted an end cap securing screw 320. The end cap 270 and 280 are affixed to the rail 10 by aligning the end cap tab 282 and the end cap expansion joint 290 into the rod block receiver groove 30 and pushing the end cap 270 and 280 into the rod block receiver groove 30. Subsequently, the end cap securing screw 320 is turned into the square nut 310, driving the end cap securing screw 320 into the end cap expansion joint 290, which drives the sides of the end cap expansion joint 290 against the walls of the rod block receiver groove 30, thereby wedging the end cap 270 and 280 into place.

Both rails 10 of this embodiment have a right end cap 270 installed into the right end of the rail 10 as previously described. Only the rail 10 that does not include the locking mechanism 55 has a left end cap 280 installed into the left end of the rail 10. This is because the rail 10 that includes the locking mechanism 55 instead uses the lock side cap 140 instead.

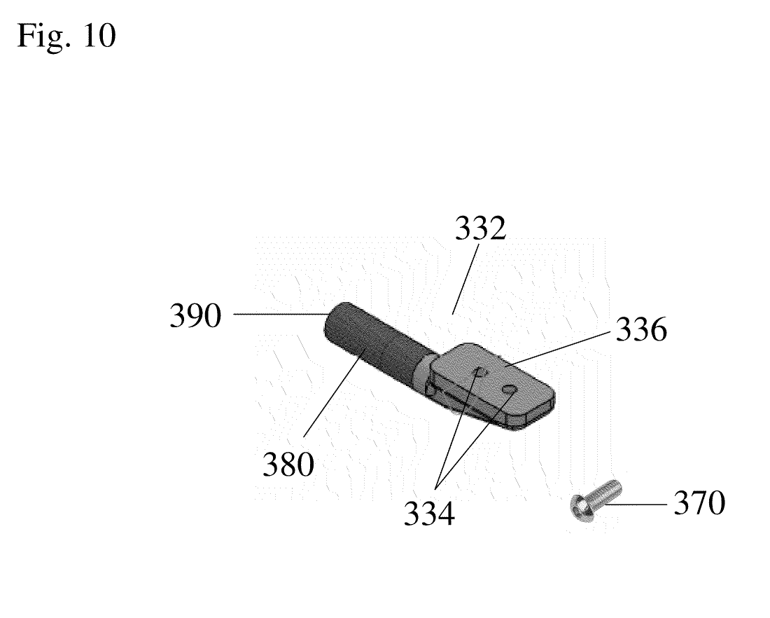

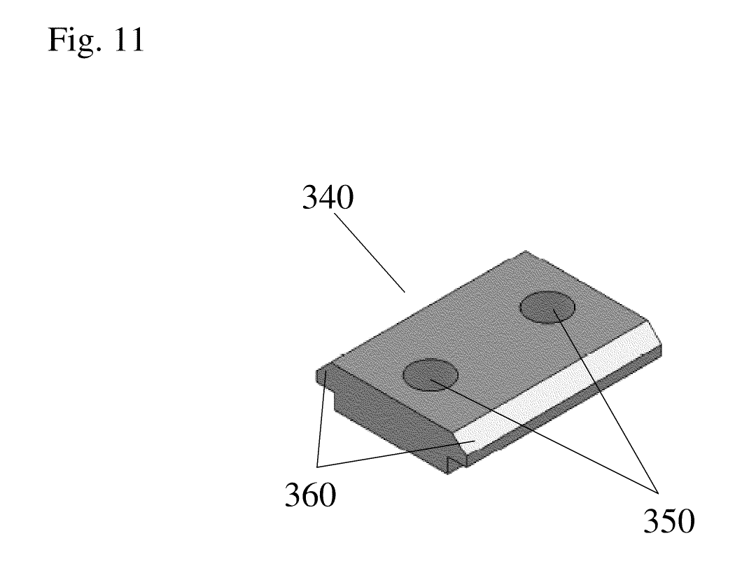

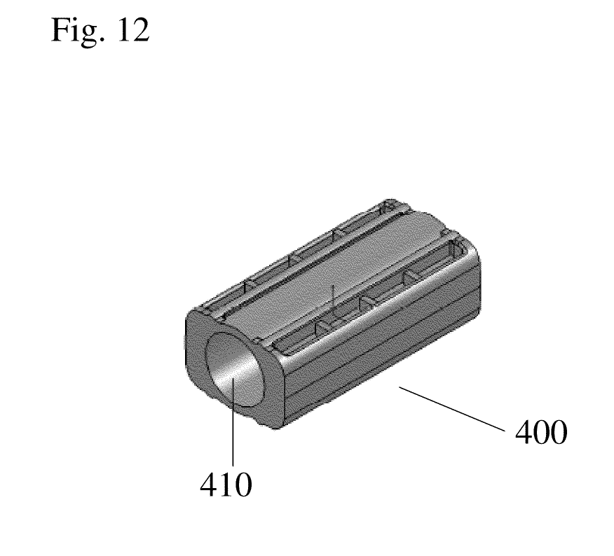

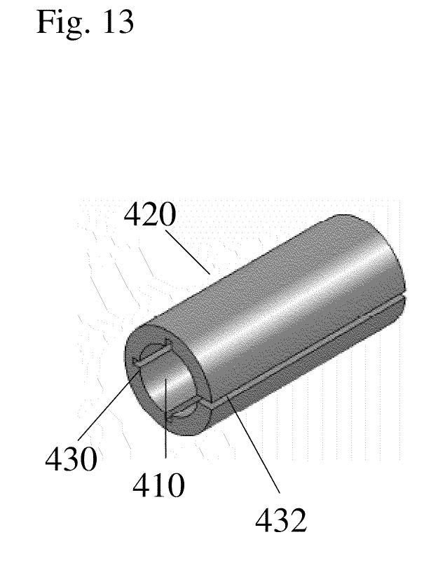

Each rail 10 has a rail adapter assembly 330 installed to accommodate mounting the rail assembly 510 onto the vehicle. The rail adapter assembly 330 includes a universal rail adapter 332, shown in FIG. 10, an adapter retention plate 340, shown in FIG. 11, a set of adapter security screws 370 and either an adapter rectangular sleeve 400, shown in FIG. 12, or an adapter circular sleeve 420, shown in FIG. 13. The adapter retention plate 340 incorporates retention plate beveled shoulders 360 that allow the adapter retention plate 340 to slide into the rod block receiver groove 30. The adapter retention plate 340 also incorporates two retention plate threaded holes 350.

After sliding the adapter retention plate 340 into the rod block receiver groove 30, the universal rail adapter mounting holes 334 are aligned with the retention plate threaded holes with the flat bottom surface 336 of the universal rail adapter 332 placed along the bottom of the rail 10, spanning either side of the rod block receiver groove 30. The adapter security screws 370 are a variety of fasteners that require a specialized tool to allow them to be installed or removed, thereby preventing unauthorized removal of the rail adapter assembly 330. Two adapter security screws 370 are then placed through the universal rail adapter mounting holes 334 and threaded into the retention plate threaded holes 350, thereby securely mounting the universal rail adapter 332 to the rail 10.

The end of the universal rail adapter 332 opposite the universal rail adapter mounting holes 334 encompasses the adapter round extension 390, which has a textured surface 380. Subsequently, either an adapter rectangular sleeve 400 or an adapter circular sleeve 420 slides onto the adapter round extension 390 by fitting the adapter round extension 390 into the adapter round adjuster hole 410 that runs through the middle of either the adapter rectangular sleeve 400 or the adapter circular sleeve 420. The adapter circular sleeve features several circular sleeve compression slots 430 cut transversely across the inside surface of the adapter circular sleeve to assist in securing it to the adapter round extension 390. In addition, the adapter circular sleeve 420 features a circular sleeve fit slot 432 so that the adapter circular sleeve 420 can be expanded and more easily fit over the adapter round extension 390.

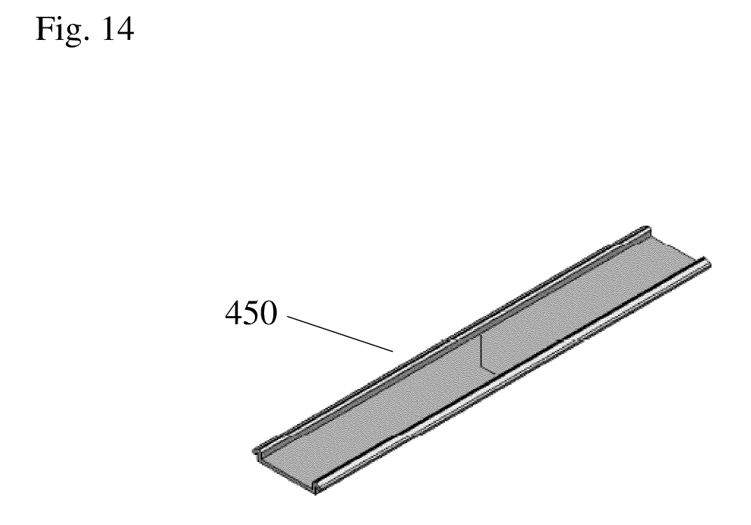

A close out panel 450, shown in FIG. 14, is installed into the close out panel receiver groove 40. The close out panel 450 is typically cut into three pieces, one to fit between the two universal rail adapters 332, and two to feet between the outside of each universal rail adapter 332 and the end of each rail 10.

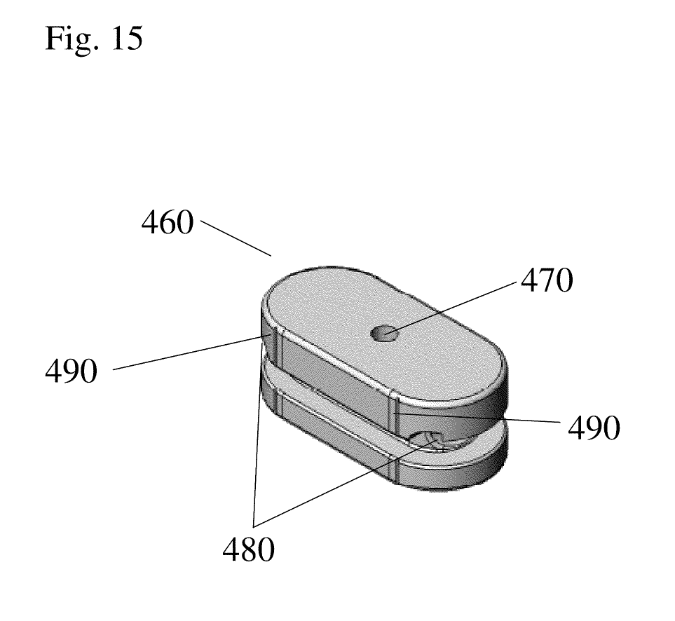

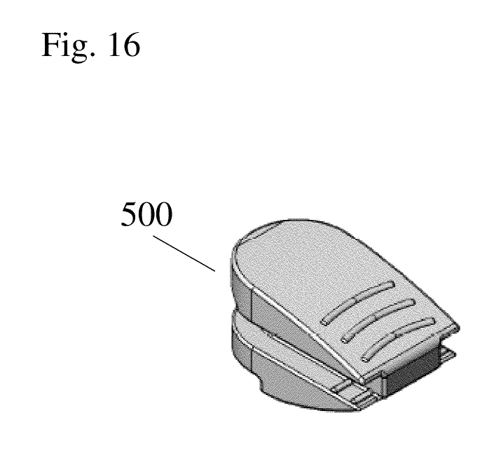

The embodiment also contemplates the use of a series of slide mounting blocks or locking members 460, shown in FIG. 15. Each slide mounting block 460 incorporates a threaded connector hole 470 that runs from the center of the top through the center of the bottom of the slide mounting block 460. At each end of the slide mounting block 460 is a securing notch 480. Around the circumference of the slide mounting block 460 is an insertion groove 490 that mates with the insertion tabs 52 of the standard slider receiver opening 50. Each slide mounting block is then symmetrical from front-to-back. A sliding plug block 500, shown in FIG. 16, is an asymmetrical block that, when inserted into a standard slider receiver opening 50, matches the curvature of the rail 10, thereby filling in each standard slider receiver opening 50 and creating an unbroken surface.

Upon mounting the front and rear rails 10 to a set of either round or square holed rooftop towers, the user utilizes the adapter round adjuster hole 410 by rotating each of the rails 10 such that the insertion tabs 52 within the standard slider receiver openings 50 are parallel and in the same plane. Once this has been accomplished, the user tightens the rooftop towers to compress either the adapter rectangular sleeve 400 or the adapter circular sleeve 420 onto the adapter round extension 390. The textured surface 380 on the adapter round extension 390 provides mechanical grip to hold each rail 10 in this position. Further, in the case of the adapter circular sleeve 420, the compression of the circular sleeve compression slots 430 aids in holding each rail 10 in position. The parallel orientation will facilitate the sliding on and off of attachments as described in the following step.

Using a standard set of fasteners, a user affixes a set or sets of slide mounting blocks 460 to an attachment, such as a bike rack or a box. The slide mounting blocks 460 function as locking members to connect the attachment to the rails 10. In the case of a narrow attachment such as a bike rack, two slide mounting blocks 460 are affixed to the attachment, one at the front of the attachment and one farther rearward on the attachment.

In the case of a wider attachment such as a cargo box, a wire basket or a ski rack, two sets of slide mounting blocks 460 are required. The slide mounting blocks 460 would be configured two in the front and two farther rearward and would be affixed at a distance side-to-side equivalent to the consistent center-to-center distances of the rail standard slider receiver openings 50. If the attachment does not accommodate the appropriate spacing, an adapter can be used to accommodate the spacing or additional holes can potentially be drilled in some attachments (e.g. boxes) to accommodate the spacing.

The front and rear mounted slide mounting blocks 460 are affixed to the attachment to fit into the spacing defined by the distance between the front rail 10 and the rear rail 10 such that the front slide mounting blocks 460 will fit completely into one of the rail standard slider receiver openings 50 in the front rail 10 but may have a space between the front of the rearward mounted slide mounting block 460 and the end of the rail standard slider receiver openings 50 in the corresponding rear rail 10. This positioning is sufficient as long as enough of the rearward mounted slide mounting block 460 is inserted such that at least approximately 25% of the rearward mounted slide mounting block 460 is inserted into the rail standard slider receiver opening 50 in the rear rail 10.

In order to secure an attachment onto the rails 10, the user must first ensure that the center actuator rod flat openings 70 are facing directly up. In this way, the user effectively opens the front rail standard slider receiver openings 50 in the front rail 10. The user accomplishes this by turning the integrated lock handle 190 clockwise 90 degrees, resulting in the integrated lock handle 190 being oriented perpendicular to the main plane of the front rail 10.

Next, a user will begin sliding the front slide mounting block or blocks 460 into one or a pair of the standard slider receiver openings 50 into the front rail 10. Once the initial slide mounting block or blocks 460 start into the rail standard slider receiver opening or openings 50 in the front rail 10, the user then guides the rearward mounted slide mounting block or blocks 460 in the rear rail standard slider receiver opening or openings 50 directly in line with the front rail standard slider receiver opening or openings 50.

Once the front slide mounting block or blocks 460 are fully inserted into the rail standard slider receiver opening or openings 50 in the front rail 10, the user may then let go of the attachment and place additional attachments on the rails 10 until all desired attachments are positioned as the user wishes. Because the slide mounting blocks 460 are symmetrical, attachments can be reversed 180 degrees front-to-back or back-to-front and placed as desired.

Once all attachments are placed to the satisfaction of the user, the user engages the securing mechanism 55 by grasping the integrated lock handle 190 and turning by 90 degrees the center actuator rod 60. This action results in the round portions of the center actuator rod 60, which are opposite and adjacent the center actuator bar flat openings 70, securing into the securing notch 480 in each of the slide mounting blocks 460 attached to each of the desired attachments, which secures all of the attachments in place.

To lock the attachments onto the rail 10, and to prevent unauthorized tampering with the locking mechanism 55, the user may engage the plunger handle lock 230 by simply pushing it in, thereby engaging the plunger handle lock dead bolt 250 into the lock insert 180. This prevents the integrated lock handle 190 from rotating, so the slide mounting blocks 460 cannot be removed from the rail 10.

In order to remove attachments, the user inserts a key 252 into the Plunger Handle Lock Key Receiver 260 and turns the key 252 to disengage the plunger handle lock dead bolt 250 from the lock insert 180. In this way, the integrated lock handle 190 can now be rotated. The remainder of the aforementioned processes are simply reversed.

It is possible and often desirable to affix and remove various attachments with their related equipment (e.g. bikes, skis, kayaks) remaining affixed to the corresponding attachment. Once removed, each attachment with its related equipment remaining affixed can then be stored on a similar set of rails 10 that have been conveniently mounted in any number of locations the user desires.

For example, the user may have a rail or rails 10 attached to a wall or ceiling in locations including her garage, storage room or any other location that may be convenient for her. Attachments such, as boxes or wire baskets, may be removed and easily stored in this way because these storage rails 10 will have identical standard slider receiver openings 50 and identical center-to-center distances of the rail standard slider receiver openings 50. When the user is again ready to transport and/or use these items, they are easily removed from the storage rails 10 and placed on the vehicle rails assembly 510.

When a standard slider receiver opening 50 is not in use, the user may insert a sliding plug block 500 into the standard slider receiver opening 50, which locks into place in the same manner as the slide mounting block outlined previously. The sliding plug block serves to further reduce wind noise and protect the internal rail 10 mechanisms from weather and debris.

Accordingly, the reader will see that, according to one embodiment of the invention provides users with an easy to use roof-rack system allowing for easy-on and easy-off solutions with integrated storage of both attachments and related equipment. This also benefits users with lower wind noise, reduces wear-and-tear on components and improved gas mileage by easily removing unused attachments and equipment.

While the above description contains many specific structures for the present invention, these should not be construed as limitations on the scope of any embodiment, but as exemplifications of various embodiments thereof. Many other ramifications and variations are possible within the teachings of the various embodiments.

For example, different materials may be used for each of the components of the invention (aluminum, plastic, stainless steel, brass, etc.) and may be post-consumer/recycled materials.

The specific dimensions and shapes of each of the components may differ. The invention relates to the relationship between the rails and slide mounting blocks, as described, for easy attachment of the attachments to the rails. The design of each of the components may also be changed. For example, instead of fitting into a single slot, slide mounting blocks 460 may be configured to fit into multiple standard slider receiver openings 50 simultaneously. Similarly, the “male” and “female” aspects of the slide mounting blocks 460 and standard slider receiver openings 50 illustrated here may be reversed such that the slide mounting blocks 460 fit over a male tab.

It may be possible to utilize a series of “tracks” and “cars” that may serve in place of the standard slider receiver openings 50 and slide mounting blocks 460 described herein.

The locking mechanism 55 may be configured as a side-to-side lever or sliding mechanism that locks into the slide mounting blocks 460 as opposed to the 90 degree turn of the center actuator rod 60 embodied previously. The locking mechanism 55 may be configured to rotate either more or less than the 90 degree turn of the center actuator rod 60 embodied previously.

The configuration of the standard slider receiver openings 50 may be reversed to face forward instead of backward. Configuration of the standard slider receiver openings 50 may be changed to be opposing with one facing forward and one facing backward or to be facing each other.

According to another embodiment, a mechanism using a trigger may be used on the rail 10 that alternately opens and closes a set of pins that may be mounted on either the rail 10 or the slide mounting blocks 460 that would fit into a concomitant set of openings to secure and release the slide mounting blocks 460 into and out of the standard slider receiver openings 50.

The various bearing surfaces may utilize any number of bearings including, but not limited to, roller bearings, needle bearings or ball bearings. A strip or strips of material to reduce friction may be placed on the rail 10 to aid in the placement and removal of the slide mounting blocks 460 into the standard slider receiver openings 50.

The rail assembly 510 may utilize a series of ball plungers and/or spring plungers to aid in secure the slide mounting blocks 460 from moving or rattling once they are in place.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A roof rack system comprising:
at least one crossbar;
a locking mechanism coupled to the at least one crossbar moveable between an unlocked position and a locked position;
an item holder for holding an item on the roof rack system, positionable substantially perpendicular to the at least one crossbar; and
wherein the item holder includes a locking member mating with the locking mechanism such that the locking member is movable substantially perpendicular to the at least one crossbar from a detached position to an attached position when the locking mechanism is in the unlocked position and is retained in the attached position when the locking mechanism is in the locked position.

2. The roof rack system according to claim 1, further comprising a positioning member coupled to the at least one crossbar and mating with the locking member when in the attached position such that the locking member cannot move vertically relative to the at least one crossbar nor parallel with the at least one crossbar when in the attached position.

3. The roof rack system according to claim 2, wherein the at least one crossbar includes a first crossbar and a second crossbar, the first crossbar being coupled with the locking mechanism and the positioning member;
the roof rack system further comprising a second positioning member coupled to the second crossbar and wherein the item holder includes a third positioning member mating with the second positioning member when in the attached position such that the third positioning member cannot move vertically relative to the second crossbar nor parallel with the second crossbar when in the attached position.

4. The roof rack system according to claim 1, wherein the locking mechanism includes a removable key for moving the locking mechanism from the locked position to the unlocked position.

5. The roof rack system according to claim 1, wherein the locking mechanism is retained within the at least one crossbar.

6. The roof rack system according to claim 5, wherein the locking mechanism includes a rod which rotates within the at least one crossbar to move between the locked position and the unlocked position.

7. The roof rack system according to claim 6, wherein the locking mechanism includes a removable key positioned at an end of the at least one crossbar for rotating the rod from the locked position to the unlocked position.

8. The roof rack system according to claim 1, wherein the locking mechanism includes a plurality of joined locking mechanisms positioned along the at least one cross bar; and
the roof rack system further comprising a second item holder for holding an item on the roof rack system, positionable substantially perpendicular to the at least one crossbar; and
wherein the second item holder includes a locking member mating with one of the plurality of joined locking mechanisms such that the locking member is movable substantially perpendicular to the at least one crossbar from a detached position to an attached position when the locking mechanism is in the unlocked position and is retained in the attached position when the locking mechanism is in the locked position.

9. The roof rack system according to claim 1 further comprising:
a bracket attachable to a vertical surface, the bracket mating with the locking member of the item holder so that the item holder can be retained on the vertical surface.

10. A roof rack system comprising:
at least one crossbar;
a locking mechanism within the at least one crossbar moveable between an unlocked position and a locked position;
an item holder for holding an item on the roof rack system, positionable substantially perpendicular to the at least one crossbar; and
wherein the item holder includes a locking member mating with the at least one crossbar mechanism such that the locking member is movable with respect to the at least one crossbar from a detached position to an attached position when the locking mechanism is in the unlocked position and is retained in the attached position when the locking mechanism is in the locked position.

11. The roof rack system according to claim 10, further comprising a positioning member coupled to the at least one crossbar and mating with the locking member when in the attached position such that the locking member cannot move vertically nor horizontally relative to the at least one crossbar when in the attached position.

12. The roof rack system according to claim 11, wherein the at least one crossbar includes a first crossbar and a second crossbar, the first crossbar including the locking mechanism and the positioning member;
the roof rack system further comprising a second positioning member coupled to the second crossbar and wherein the item holder includes a third positioning member mating with the second positioning member when in the attached position such that the third positioning member cannot move vertically nor horizontally relative to the second crossbar when in the attached position.

13. The roof rack system according to claim 11, wherein the locking mechanism includes a removable key for moving the locking mechanism from the locked position to the unlocked position.

14. The roof rack system according to claim 11, wherein the locking mechanism includes a rod which rotates within the at least one crossbar to move between the locked position and the unlocked position.

15. The roof rack system according to claim 14, wherein the locking mechanism includes a removable key positioned at an end of the at least one crossbar for rotating the rod from the locked position to the unlocked position.

16. The roof rack system according to claim 14, wherein the rod extends along a length of the at least one crossbar, the crossbar includes a plurality of positioning members associated with the locking mechanism along the length of the at least one crossbar; and each of the positioning members being able to mate with the locking member of the item holder when in the attached position such that the locking member cannot move vertically nor horizontally relative to the at least one crossbar when in the attached position.

17. The roof rack system according to claim 11 further comprising:
a bracket attachable to a vertical surface, the bracket mating with the locking member of the item holder so that the item holder can be retained on the vertical surface.

18. A roof rack system comprising:
four stands attachable to a roof of a vehicle;
two crossbars, each crossbar extending across the roof of the vehicle between a respective two of the stands, each crossbar being substantially greater in width than in height; and
a plurality of attachment mechanisms, each attachment mechanism being positioned between a crossbar and a stand, the attachment mechanisms being arranged so that each crossbar is rotatable about an axis parallel to the length of the crossbar.

19. The roof rack system according to claim 18, further comprising:
an item holder having at least one first positioning member on a lower surface thereof;
wherein each crossbar includes a plurality of second positioning members positioned along its length;
wherein the first positioning member and second positioning members are arranged to mate so that the first positioning member may be slid into the second positioning member perpendicularly to the length of the crossbar.
